(19) United States
(12) Patent Application Publication
(10) Pub. No.: US 2003/0058084 A1
(43) Pub. Date: Mar. 27, 2003

(54) Method and apparatus for securing passage on a common carrier and creating a passenger manifest

(76) Inventor: Sean M. O'Hara, Lebanon, OR (US)

Correspondence Address: HEWLETT-PACKARD COMPANY, Intellectual Property Administration, P.O. Box 272400, Fort Collins, CO, 80527-2400, US

(21) Appl. No.: 09/963,183

(22) Filed: Sep. 25, 2001

(51) Int. Cl. H04Q 1/00; G05B 19/00

(52) U.S. Cl. 340/5.53; 340/5.6

(57) ABSTRACT

Security on airplanes and other common carrier carriages is enhanced by establishing the identity of travelers and documenting their true identity as established by biometric characteristics that irrefutably identify an individual. A biometric characteristic is measured at the time of ticketing. The biometric characteristic is measured at the time of boarding to insure that the person who purchased passage and the person who boards are one and the same. Electronic copies of identifying data can be stored and shipped to external data bases.

### BACKGROUND OF THE INVENTION

Airlines have the responsibility of keeping accurate records of people on a flight in case there is an accident. In such an event, the National Transportation Safety Board requires an accurate list of who was on a flight. Errors in manifests could be virtually eliminated by use of a biometric verification device.

Not only is this a very accurate way to create a manifest of passengers/crew, but it is also a way to provide greater safety and security. It allows for a record to be generated of a person that can now be compared against a database of terrorist/criminal/most wanted/etc. This search could be performed between check-in time at the main gate and boarding time at the airplane gate. Searching could even be performed during the flight time to attempt for identification of wanted people.

One of the largest roadblocks in a device such as this is the “loss” of freedom that people feel when they have to scan in their identification/fingerprint and have it accessible for searching. On the other hand, the reassurance that it may potentially give the majority of passengers could potentially outweigh any bad feelings of such invasion of privacy.

If people felt that it was simply a way to ensure safety and accuracy in the case of an emergency, people may be more willing to accept the incorporation of the device into travel. From the aspect of helpfulness to the NTSB in the event of an accident, it could be very beneficial having on file the fingerprints of passengers for identification needs.

### BRIEF DESCRIPTION OF THE DRAWINGS

FIG. 1 depicts a simplified block diagram of a security system for use with common carriers to establish a traveler's identity at the time of ticket purchase and boarding.

FIG. 2 shows an alternate embodiment of the system in FIG. 1.

FIG. 3 shows a flow chart of the process steps performed at a check-in terminal depicted in FIGS. 1 and 2.

FIG. 4 shows the steps of a process by which biometric data is sent to a third party for archival and analysis.

FIG. 5 shows the steps of a process by which biometric data is analyzed by a third party for identification.

FIG. 6 shows the process steps performed at a gate terminal proximate to the time a traveler would board a common carrier.

FIG. 7 shows the steps of an alternate embodiment of the process performed by a check in terminal shown in FIG. 3 wherein biometric data is copied onto a boarding pass.

FIG. 8 shows the steps performed by a gate terminal when the steps of FIG. 7 are performed at the check-in terminal.

FIG. 9 shows the steps of another embodiment by which biometric characteristics are measured and used to issue or deny a boarding pass.

FIG. 10 shows a simplified flow chart of the steps performed to scan a finger print.

FIG. 11 shows a simplified flow chart of the steps performed on a digital photograph.

### DETAILED DESCRIPTION

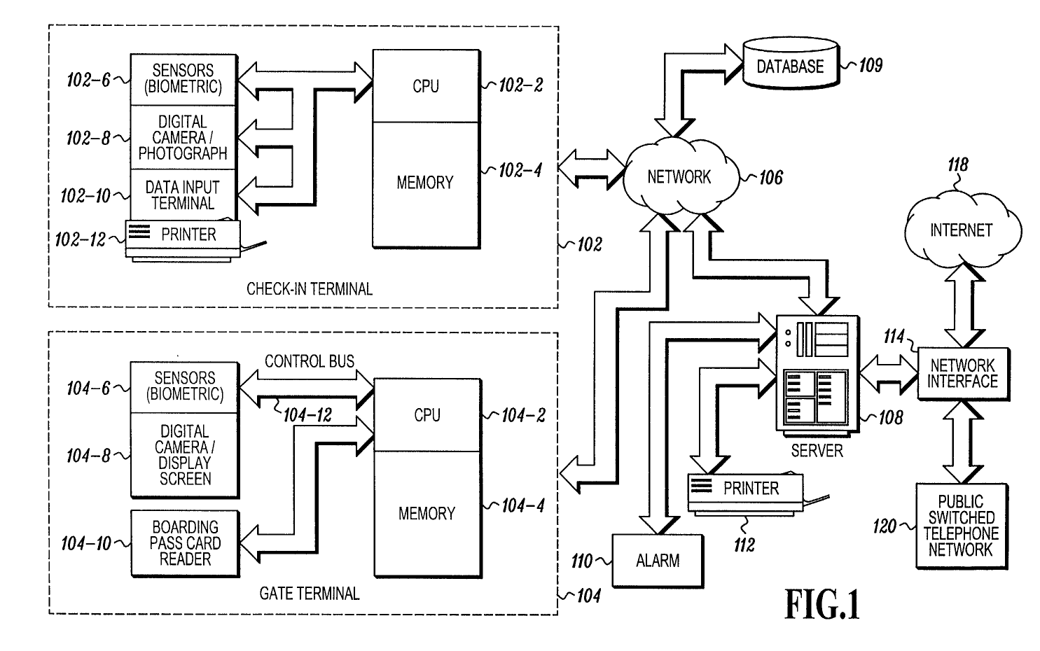

FIG. 1 depicts a block diagram of a biometric characteristic airport security system 100. The system 100 is comprised of a check-in terminal 102 (also considered to be a ticketing terminal) and a gate terminal 104 that communicate with each other through a data network 106. The data network 106 to which the check-in terminal and the gate terminal 104 are coupled enables the ticketing terminal 102 and the gate terminal 104 to share data with each other as well as a server 108, which among other things functions as a repository of data collected and processed as described hereinafter and which is embodied as one or more computers and associated storage devices, known to those of ordinary skill in the art.

The network 106 that couples the server 108 and the check-in terminal 102 and the gate terminal 104 together can be embodied as an Ethernet network or any other network architecture and protocol that will allow large amounts of data to be quickly exchanged between numerous computers. In an actual deployment of the invention in an airport, several check-in terminals 102 and several gate terminals 104 would need to communicate with the server 108 or each other.

The server 108 is operatively coupled to an alarm mechanism or mechansims 110, an output device such as a printer 112 and a network interface 114 that provides communications to other networks such as the Internet 118 or the public switched telephone network 120.

The system 100 operates by collecting the biometric characteristics of a traveler (finger print, voice print, retinal scan, DNA scan, photograph) at the time the traveler purchases passage on a common carrier. The biometric characteristics that are collected are stored in a central repository where they can be later recalled. At the time of boarding, the identity of the persons boarding can be confirmed to be the same as those who purchased passage thereby assuring that the person identified to the carrier at the time of ticketing is the person who actually boarded. A photograph and a finger print, retinal scan or DNA scan of the traveler unambiguously identifies the traveler, even if documentary identification provided to the carrier at the time of ticketing was fraudulent. This provides a detailed manifest of passengers on a flight or other carrier by the collection of data at check in, including the collection of biometric data. In addition to collecting a detailed manifest of passengers, detailed information on each passenger is collected and available for subsequent uses. By using electronic scanners and digital cameras coupled to appropriately fast computers, the time required to collect data and generate detailed passenger manifests is reduced as much as possible.

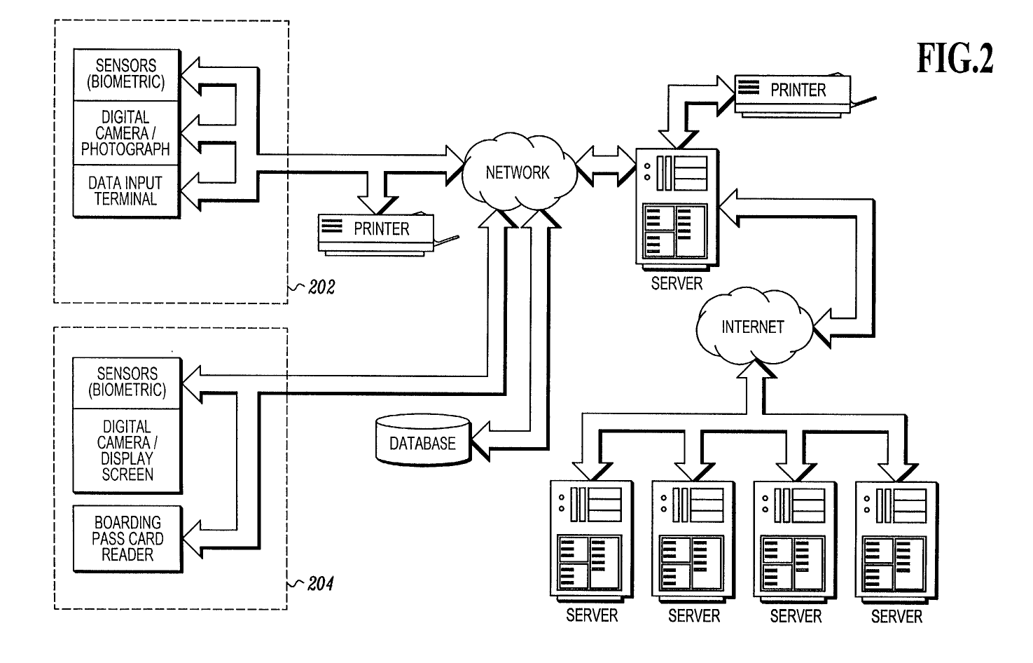

FIG. 2 depicts an alternate embodiment of the system shown in FIG. 1. In FIG. 2, the biometric sensor, camera, terminal and printer are coupled to the server 108 via the data network 106. No local processor is used. Although the terminals 202 and 204 shown in FIG. 2 do not show a local processor, the functionality of both systems in FIG. 1 and FIG. 2 are considered to be equivalent.

The functions of the terminals depicted in FIG. 1, and the alternate embodiment depicted in FIG. 2, are shown in flow charts depicted in the other figures. The functions of the different terminals are presented separately hereinafter.

The ticketing terminal 102 is comprised of a processor 102-2 and its associated memory 102-4 to which the processor 102-2 is coupled by an address and control bus. Similar to the terminals that are commonly found in airports today whereat passenger information is entered and from which ticket and boarding passes are issued and printed, the ticketing terminal 102 performs the same functions as prior art terminals, however, the ticketing terminal 102 depicted in FIG. 1 includes additional equipment and the capability to obtain biometric characteristics of an individual. The ticketing terminal 102 includes a processor (CPU) 102-2, typically a microcomputer or microprocessor, which executes program instructions and operates on data that are stored in its associated memory 102-4. The program instructions executed by the processor 102-2 and the data that the processor 102-2 operates, effect the steps of the methodology depicted in the figures discussed hereinafter.

The processor 102-2 communicates with the memory 102-4 via an address and control bus, well known to those of skill in the art. Also coupled to the CPU 102-2 via the address and control bus is at least one biometric sensor 102-6, the purpose and function of which is to convert biometric characteristics of an individual into data that represents the biometric characteristic of the individual. Biometric characteristics are physical characteristics that uniquely identify an individual and would include, but are not limited to one or more finger prints (including the thumb), retinal patterns, voice prints (frequency components as measure by a Fourier analysis for instance) and DNA. Examples of biometric sensors include retina scanners, fingerprint scanners, voice frequency component scanners, and possibly DNA strand scanners and a camera, all of which for claim construction purposes are considered to be equivalents under the monikers of “biometric sensors” and “biometric scanners” used hereinafter. While one biometric sensor 102-6 is shown in conjunction with the check-in terminal 102, alternate and equivalent embodiments of the invention would include using two or more sensors, such as finger print scanner and a camera; a finger print scanner and a voice print; a voice print and a DNA scanner and a camera and a finger print scanner.

In a preferred embodiment, the check-in terminal 102 employs a finger print scanner as one biometric sensor and a camera as a second biometric sensor, both of which are coupled to the CPU 102-2. Both such scanners generate data and have data output ports and control inputs by which the processor 102-2 can controllably obtain from them, digital data that represents biometric characteristics scanned or read from an individual.

The check-in terminal also includes a data input terminal 102-10, which includes an output display device such as a CRT or liquid crystal display and a conventional keyboard, such as well-known QWERTY-style keyboard by which input data can be entered into the processor 102-2. Like the terminals commonly used in airport ticketing terminals today, the data input terminal 102-10 enables the input of information such as a traveler's name, address, destination, method of payment, as well as notes of a ticket agent and local control of the biometric scanners 102-6. The data input terminal 102-10 shown in FIGS. 1 and 2 enables the display of travel information in order to enable the ticket agent the ability to create a complete record of the person seeking passage on a carrier, but also including e.g., finger printing and photographing the traveler.

A printer 102-12 coupled to the CPU 102-2 through the address and control bus enables tickets and boarding passes to be printed under the control of the CPU 102-2. The printer 102-12 includes the ability to print magnetic stripes or 2-D or 3-D bar codes as described more fully hereinafter.

The purpose and function of the biometric sensor 102-6 is to read, scan or sample physical characteristics of an individual that will unambiguously (as much as the device and the associated analysis of output data will allow) identify an individual seeking transit and convert such characteristics into numeric representations that can be processed by a computer. Examples of usable biometric sensors include capacitive fingerprint sensors like those available from Veridicom, Inc., of Santa Clara, Calif., the specifications of which at the time of the filing of this application are available at the Veridicom website, www.veridicom.com.

Biometric finger print scanners are also available from Ethentica, Inc., of Aliso Viejo, Calif. The specifications of their tactile fingerprint sensors of which are available at www.ethentica.com.

Other biometric sensors 102-6 would include retinal image scanners and voice recognition devices that can identify distinctive cell patterns in a retina and distinctive frequency components and waveforms in an individual's spoken voice. Still other biometric sensors would include DNA scanners that can read the structure or organization of an individual's DNA.

In the preferred embodiment, a fingerprint sensor, such as the Veridicom Model FPS110 sensor provides a relatively high resolution image of the peaks and valleys of an individual's fingerprint using a matrix of parallel plate capacitors, one plate of each of which is formed by a user's fingertip surface (the peaks and valleys of an individual's fingerprint) and the other one of which is one of 90,000 or more plates formed on the fingerprint sensor surface. When an individual places his finger on the sensor, the finger acts as one of the plates of a dual-plate capacitor. The other plate is formed on the silicon chip containing an array of capacitor plates.

According to data provided on the Veridicom, Inc. website as of the filing date of this application, Veridicom devices are capable of sensing fingerprint characteristics at a relatively high resolution of 500 dots per inch. The Veridicom sensor creates a raster-scan image of the ridges and valleys of the fingerprint pressed against the chip. Raster-scan image data is converted by the Veridicom device to provide a video signal that is represented by 8-bit digital words that can be read by the processor 102-2 via address and control bus output lines of the processor 102-2. The 8-bit words representing a raster-scan image from the sensor 102-6 can be compressed, indexed by hash coding or a check sum calculation in order to compress and more-readily identify data that uniquely identifies the individual who owns the thumb or finger from which the raster-scanned image was obtained.

In a preferred embodiment, a digital camera 102-8, which is also coupled to the processor, 102-2 provides the capability of and functions to obtain a digital photograph of an individual under the control of the CPU 102-2.

For purposes of claim construction, biometric sensors are devices that can sense or detect physical characteristics that can be used to uniquely identify a particular individual. Accordingly, biometric sensors would exclude devices that measure a person's weight, height, hair color, eye color, and temperature.

The system depicted in FIG. 1 and the process steps it performs and which are depicted in the other figures is applicable to securing passage on other forms of common carriage such as rail, ship or bus. An individual seeking to travel on a common carrier, such as an airline, train, ship or bus, (for claim construction purposes to be equivalents and denominated as common carrier carriage devices or equipment) would request passage on the common carrier by payment of a ticketing fee and issuance of a ticket and/or boarding pass required to physically gain access to the common carrier's facilities or device (i.e., airplane, train or bus).

As is well known, the ticketing procedure for air travel requires among other things, that the individual announce their destination, select from a flight or available flights to that destination, payment of a fee and acceptance of a ticket followed by issuance of a boarding pass. The boarding pass is a separate document printed by the airline and issued to the traveler, who presents the pass to an agent of the carrier or facility at the gate where entrance to the carriage (plane, ship, bus, train) is provided in order to be allowed physical entry to the airplane. In the ticketing terminal 102 shown in FIG. 1, the procedure for ticketing a passenger and issuing a boarding pass would need to be only slightly revised from that which is currently practiced in the art but includes several new procedures or steps heretofore not practiced but which are depicted in various embodiments as shown in the figures.

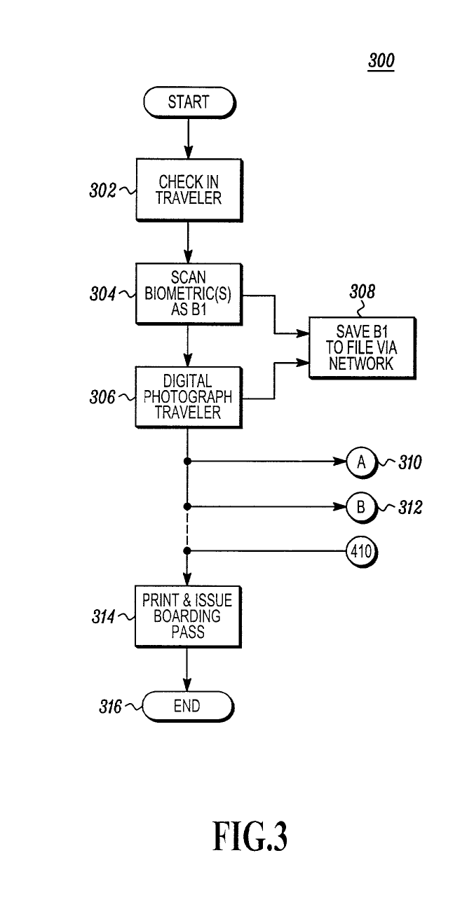

FIG. 3 shows a flow chart of the steps of a method that is part of a procedure for securing the passage of travelers on a common carrier 300 beginning at the check-in terminal 102 and as a result, collecting information from which a detailed passenger manifest can be produced. With respect to the check-in terminal 102 (also referred to herein as a “ticketing terminal”) shown in FIG. 1, personnel of a carrier, some times referred to as a ticketing agent, performs an initial check-in of a traveler in Step. 302.

The check-in process as it is known today includes perfunctory questions to the traveler such as the traveler's intended destination and departure time, seat selection and the like. FAA regulations require the presentation of photograph identification. In the prior art check-in process, the ticketing agent at one of several such terminals regularly found in most airports, provides a first inspection of documents that ostensibly identify the traveler. In step 302 of the process depicted in FIG. 3 however, the check-in procedure 302 would include additional steps including the demand by the ticketing agent for a finger print or thumb print, retinal scan, voice sample or photograph. One or more computers (e.g., 102-2) read data that is output from the scanning devices that acquire such information and store it for future retrieval and analysis.

In a preferred embodiment, the biometric sensors 102-6 are employed at a ticketing terminal to obtain from a traveler, a biometric characteristic measurement by requiring the traveler to place their thumb or another fingerprint on the inspection window of the aforementioned biometric scanner and obtaining therefrom, data representative of the physical characteristics of the air traveler who presumably identified them self to a ticketing agent using the aforementioned documents. In addition to using a fingerprint scanner, the biometric sensors 102-6 used in Step 304 might include a retinal scan or DNA scan or voice print as mentioned above. Inasmuch as a camera can capture an image of an individual, a camera can be considered to be a biometric sensor as well. A process of determining or reading or scanning a biometric characteristic such as a finger print, voice print, DNA scan or retinal scan is considered to be any process by which physically measurable characteristics that unambiguously identify a particular person is obtained and from which data representing the characteristic can be generated. Converting the biometric characteristic into data or other electrical signals is part of a process of generating or creating data corresponding to or representing the characteristic, typically performed by the biometric sensor, such as the aforementioned Veridicom sensor.

In Step 306, a digital photograph of the traveler is taken by the digital camera 102-8 under the control of the processor 102-2. The biometric scan data from the scanner 102-6 after any associated processing by the CPU 102-2 is denominated in FIG. 3 as B₁. The digital photograph data and scan data are preferably stored together on a server 108 via a data network 106. Having the biometric scan and the digital photograph stored to a server computer 108 accessible via a network 106 makes the data available from other computers that are also coupled to the network 106. It also makes it possible to identify a traveler by his or her photograph as well as a fingerprint or thumb print or other biometric characteristic. The server 108 can function to compare the biometric data (obtained from the biometric sensor acquisition of a biometric characteristic) obtained at the check-in terminal 104 to later-acquired biometric data, such as that acquired at the biometric sensor 104-6 of the gate terminal 104.

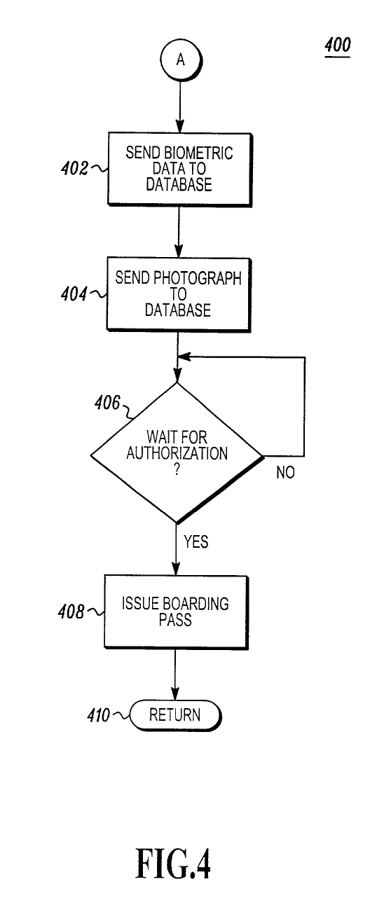

In FIG. 3, optional procedures A and B identified by reference numerals 310 and 312 can be invoked and executed in alternate embodiments of the invention. FIG. 4 shows a simplified flow chart of the steps of procedure 310 by which biometric data can be sent to an external database in Steps 402 and 404. Such an external database might include a database operated by a third-party data collection agency but would also include data bases maintained by or for law enforcement agencies. By sending biometric scan data B₁ and perhaps a digital photograph of a traveler obtained in Step 306 in Steps 402 and 404 respectively, common carriers who use the invention disclosed herein can readily and uniquely identify persons seeking to travel on its equipment. Moreover, law enforcement agencies can be assisted in the creation of a database of individuals who use common carriers such as airlines and thereby provide data that might be of assistance in tracking individuals responsible for the undertaking of criminal acts on, or using common carriers.

In FIG. 4, optional Step 406 waits for an acknowledgement from a law enforcement agency or database operator that the biometric data and photographic scan data (if sent) is not identified with or corresponding to known criminal suspects. In optional Step 408 wherein an authorization message is sought, if an authorization message is received from a law enforcement agency approving of the issuance of travel services to the individual identified by the biometric scan data, an acknowledgment message returned from the law enforcement agency or database operator would result in the issuance of a boarding pass in Step 408. Program control returns in Step 410 to Step 314 in FIG. 3 that is the printing and issuance of a boarding pass to the traveler.

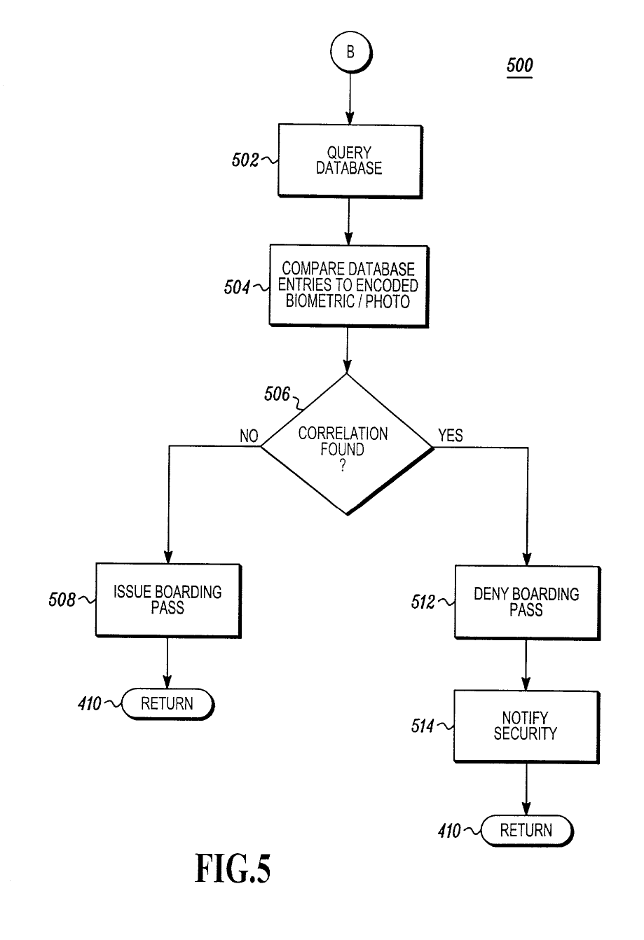

Optional procedure B, identified by reference numeral 312 in FIG. 3, is depicted in FIG. 5. FIG. 5 depicts the steps by which law enforcement or other third party databases can be queried by either the server 108 (after receiving the scan data B1 and photograph) or the check-in terminal 102 as to the propriety of allowing the traveler access to the common carrier's equipment. In Step 502, an inquiry can be sent to an external law enforcement database including the biometric data (and picture) by either the processor 102-2 or the server 108, via the network interface 114 and the internet 118 or the public switched telephone network 120 inquiring as to the presence or absence of biometric characteristics of individuals matching those obtained from the sensor 102-6 in Step 304. Stated alternatively, in Step 502, a law enforcement database or a third party service provider can be interrogated remotely to determine whether or not to issue travel tickets to the individual whose biometric characteristics were scanned in Step 304 and whose picture was taken in Step 306.

In Step 504, a remote database of information on individuals who are wanted by law enforcement or who are otherwise substantial risks to a carrier can be identified and biometric data of individuals who should be prohibited access returned to the processor 102-2 or the server 108 for comparison in Step 504 to the encoded biometric data obtained in Step 304. In Step 506, if no correlation between the traveler's biometric characteristics and those of record by an external agency is found to exist, a boarding pass can be issued in Step 508 with program control returning to the procedures shown in FIG. 3 in Step 410.

If a correlation is found between biometric characteristics scanned in Steps 304 and 306 with records in an external database, in Step 512 issuance of any tickets or boarding pass can be denied followed by an optional notification of security services or law enforcement in Step 514. Program control returns to Step 410 as shown in FIG. 3.

Returning to FIG. 3, in Step 314 the boarding pass or ticket can be printed and issued following Step 306 or upon the successful determination that a boarding pass should be issued as a result of the procedures shown in FIGS. 4 and 5. If a boarding pass and ticket is issued in Step 314, the check-in, ticketing and identification procedure shown in FIG. 3 can be concluded in Step 316. A passenger manifest using data collected at the check-in terminal can be printed from the terminal 102. The collected data can also be sent to the server 108 for printing at an associated printer on the network.

Having described the components and function of the check-in terminal 102, the common carrier security system 100 shown in FIG. 1 also includes a gate terminal 104 that is coupled to the data network 106 and the server 108 so as to provide communications between the ticketing terminal 102 and the gate terminal 104.

The gate terminal 104 includes a processor or controller 104-2 and its associated memory 104-4. The processor 104-2 executes program instructions and operates on data that are stored in the memory 104-4. The instructions and data imbue the terminal 104 with the functionality depicted in the accompanying figures discussed hereinafter.

A biometric sensor 104-6 in the terminal 104 is used to scan (senses or reads) the same characteristics as does the biometric sensor 102-6. As set forth above, the server 108 can function to compare biometric data obtained from different biometric sensors. However, the processor 104-2 within the gate terminal can also perform such a comparison. Depending upon data loading on the network 106 and the server 108, in heavily loaded networks and servers, having the processor 104-2 perform the comparison of biometric characteristics might be performed faster. By comparing the biometric characteristics obtained at the check-in terminal 102 to the biometric characteristics obtained at the gate terminal 104, a confirmation that the person who bought the ticket and identified them self to the ticket agent is the same person who actually gets on the airplane, ship, train or bus. A digital camera/display screen 104-8 on which pictures and videos can be viewed and a boarding pass card reader 104-10 are also operatively coupled to the processor 104-2 via the control bus 104-12.

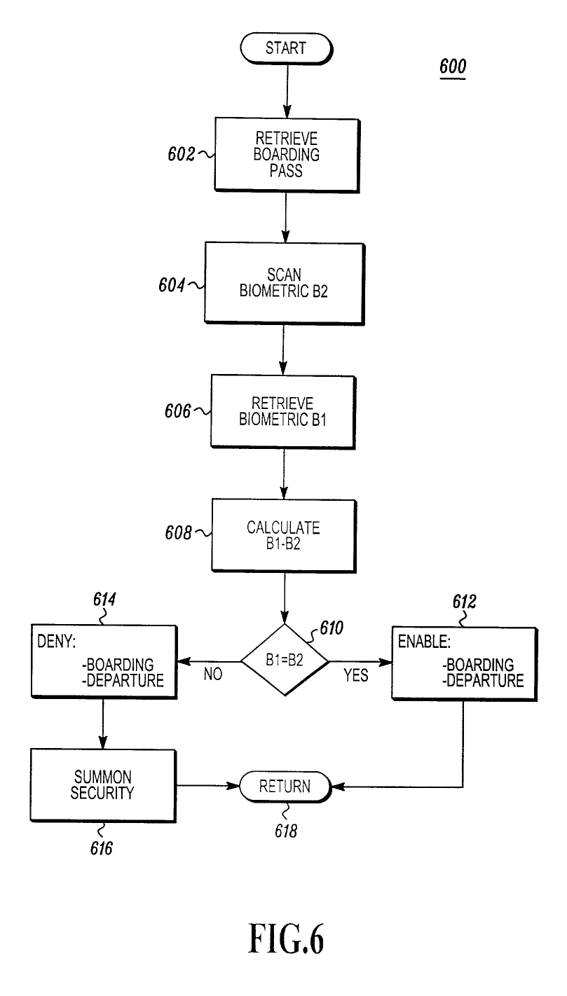

Operation of the gate terminal 104 in a preferred embodiment is depicted in FIG. 6 which shows a portion of the process for providing secure passage to travelers on a common carrier and which would likely be executed by the process 104-2. In Step 602, a boarding pass issued to the traveler in Step 314 is collected by a gate agent or inserted by the traveler. Printed (e.g., 1, 2 or 3-dimensional bar codes) or magnetically encoded information on the boarding card is read by a card reader that retrieves information encoded onto the boarding pass. In the prior art, physical collection of the boarding pass by a boarding pass reader 104-10 enables, among other things, a tally of the number of passengers actually boarding a common carrier carriage device (i.e., airplane, train, ship or bus). In the gate terminal 104, the boarding pass reader 104-10 recovers data that represents the biometric characteristics of the individual who purchased the right to board the common carrier. That data is passed to the CPU in the terminal 104 for comparison to a second biometric scan and presentation onto a display.

After the gate agent collects the boarding pass, a biometric characteristic is read or obtained in Step 604, denominated as B₂. The biometric characteristic read in Step 604 should be the same biometric characteristic that was read in Step 304. In other words, if a traveler provided a thumb print or thumb scan in Step 304, the same thumb scan or thumb print needs to be obtained in Step 604.

In Step 606, the processor 104-2 retrieves via the network 106, and preferably from the server 108, the previously read biometric scan B₁ that was obtained in Step 304. In Step 608 the initially, or first obtained scan, B₁, is calculated to the second scan of the same characteristic and compared in Step 608.

In Step 610, if it is determined that the two biometric characteristics are a match or are substantially matched to each other, in Step 612 the traveler can be enabled to board the carriage device (e.g., plane, boat, train or bus) and depart from the terminal for their destination.

If in Step 610 the biometric characteristic that was obtained from the air traveler in Step 304 does not match that which was obtained in Step 604, it can be concluded that the individual who purchased the ticket in Step 304 and the individual attempting to board the plane, train, ship or bus are different. In Step 614, upon the determination that the biometric characteristics mismatch, the carrier can deny access or boarding to the traveler and in Step 616, summon security. Program control concludes for the gate terminal 104 in Step 618 with the return to Step 602 for the next ticketed passenger.

With respect to FIG. 1, the steps of the method performed by the gate terminal 104, which are depicted in FIG. 6, are performed by the biometric sensor 104-6 and the processor 104-2 which obtains biometric scan data that was obtained at the ticketing terminal 102 and distributed via the network 106 to all gate agents that might be operating in an airport.

Upon the determination that a mismatch exists between the biometric sensors data obtained at the ticketing terminal 102 and the biometric sensor obtained at the gate terminal 104, the security system 100 shown in FIG. 1 can generate an appropriate alarm via an alarm device 110. If it is determined that the biometric data obtained at the gate terminal 104 and at the ticketing terminal 102 match, a manifest of passengers on board a carriage device can be printed from a printer 112 operatively coupled to the server 108 or to either the gate terminal 104 or the ticketing terminal 102 via the network 106 and the server 108.

As set forth above, photographic data obtained by the digital camera 102-8 and biometric sensor data from the biometric sensor 102-6 can be collected by the CPU 102-2 and printed onto a boarding pass using a printer 102-12 at the ticketing terminal 102. That data can also be stored in the memory 102-4 and the server 108 and indexed and retrieved for other purposes.

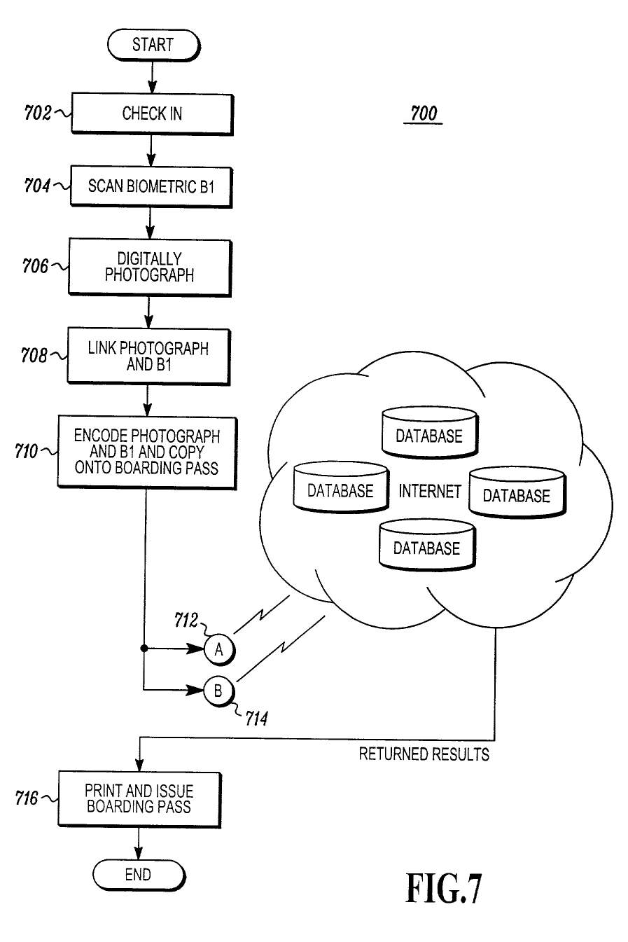

In FIG. 7, the steps of an alternate procedure performed by an alternate embodiment of a gate terminal 102 are shown. In Step 702, a traveler is checked-in using the procedure described with respect to Step 302. In Step 704, biometric characteristics can be scanned using the same steps described with respect to Step 304. In Step 706, a digital photograph obtained by the camera 102-8 can be obtained, and compressed if necessary for storage. In Step 708, biometric data obtained by the scanning Step 704 and the digital photograph can be linked in the memory 102-4 of the ticketing terminal 102 such that the photograph of the traveler obtained in Step 706 and the biometric data obtained in Step 704 can be stored together as one data structure either locally in memory 102-4 or on a server 108.

Of significance in the procedure shown in FIG. 7 is Step 710 that provides the encoding and copying of the photograph data obtained in Step 706 and the biometric data obtained in Step 704. In Step 710, the biometric data and digital photograph data are copied onto an appropriate media on either the ticket and/or boarding pass. Copying the biometric scan data and the photograph data onto a boarding pass can be accomplished in a number of ways. A magnetic stripe, a two-dimensional or three-dimensional bar code provide mechanisms by which biometric data and a photograph uniquely identify the traveler checked-in in Step 702 is copied onto his boarding pass. In Steps 712 and 714, the data on the traveler who is checked-in in Step 702 can be forwarded to external databases or databases can be queried to identify to law enforcement agencies the photograph and thumbprint seeking to travel on the common carrier. In Step 716, if there is no criminal record or other reason why a boarding pass should not be issued to a traveler, the boarding pass, including the photograph and scanned biometric data can be printed and issued to the traveler in Step 716 using the printer 102-12 at the ticketing terminal 102. In the security system 100, the gate terminal 104 can employ functionality in a boarding pass card reader 104-10 to verify that the person presenting the boarding pass at the time of boarding a common carriage device is in fact the same person who purchased the ticket.

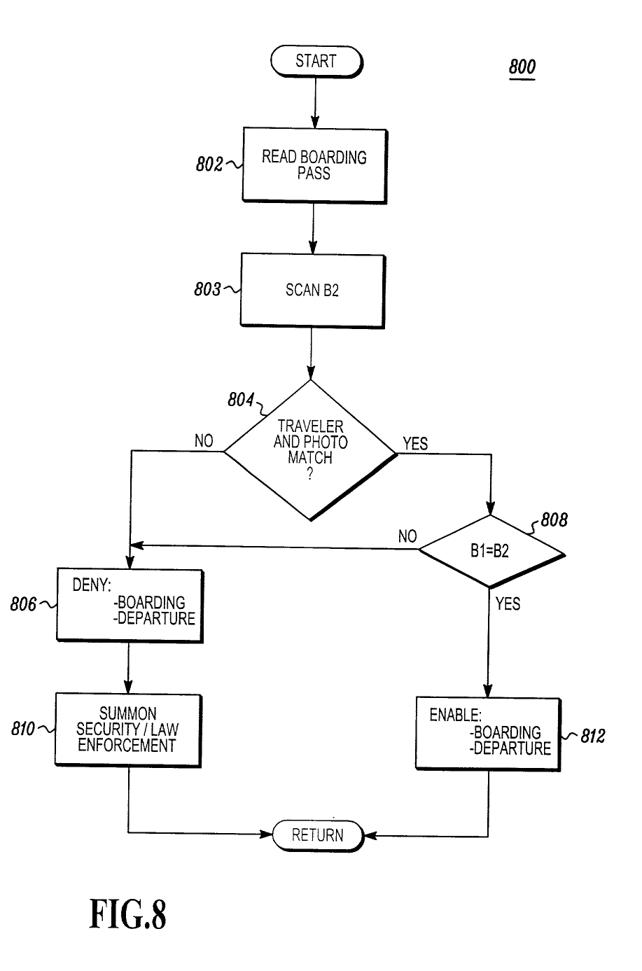

In FIG. 8, the steps performed by the gate terminal 104 include the step of reading the boarding pass data in Step 802. The boarding pass onto which the biometric data was copied and perhaps a digital photograph was copied are scanned and used to display a photograph at the gate to provide for a gate agent, a copy of the photograph of the person who purchased a ticket and presumably is the same person in custody of the physical boarding pass. Stated alternatively, the boarding pass that was printed in Step 716 is presented to the boarding pass card reader 104-10. The boarding pass card reader 104-10 reads the encoded picture data, presents the data to the CPU 104-2 which reproduces the photograph on a display such as a cathode ray tube or a liquid crystal display device that is part of the gate terminal 104. By having presented to a gate agent a photograph of the person who purchased the ticket, a gate agent can verify that the individual who identified himself in the check-in procedure 702 is the person boarding the plane, ship, train or bus.

In Step 804 of FIG. 8, a gate agent can compare the photograph of the person presenting the encoded boarding pass to the person standing before him and make a decision in Step 804 as to whether or not the photo of the person who purchased the ticket and the person before him are the same. If it appears to the agent that the person in front of him is not shown in the accompanying photograph, in Step 806, boarding and departure of the individual can be inhibited followed by summoning of security or law enforcement to take appropriate action.

In Step 804, if it appears that the photograph stored on a boarding pass and the person in front of the gate agent are one in the same, or if there is some question thereof, an additional check of the individual can be performed in Step 808 using the biometric data obtained in Step 704 and rescanned in Step 803.

If the biometric scan data obtained in Step 803 matches that obtained in Step 704, and if the photograph reproduced by the card reader 104-10 and the image of the individual in front of the gate agent matches, boarding can be enabled in Step 812.

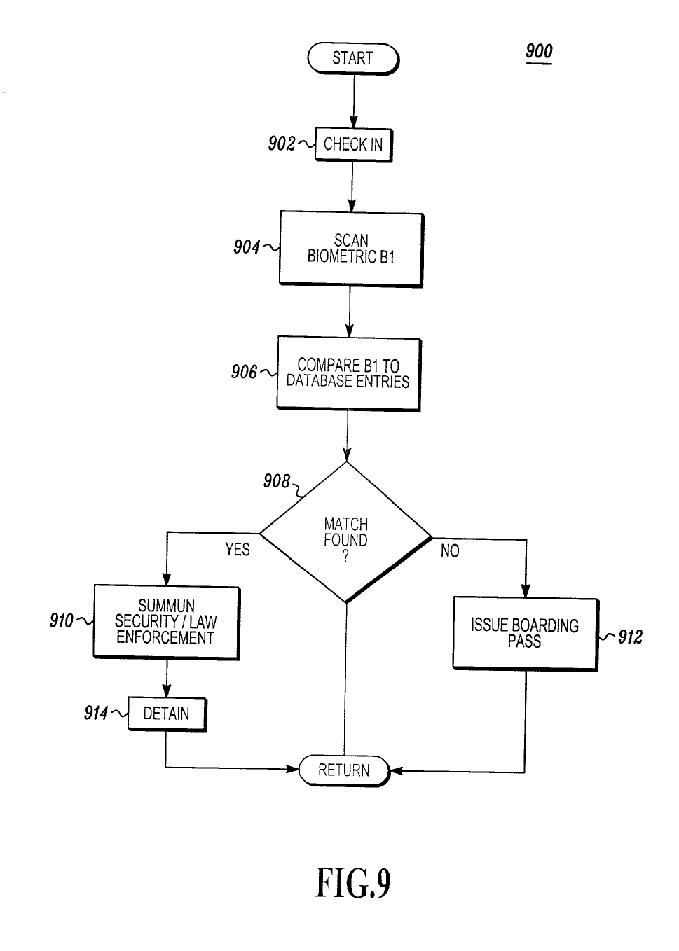

FIG. 9 shows yet another embodiment for securing safe passage of travelers on common carriers. In Step 902, as part of the aforementioned check-in process, biometric data is scanned in Step 904 and compared to database entries in a database accessible to the server 108. The biometric data obtained in Step 904 would be that read by biometric sensors 102-6 as part of a ticketing terminal 102. Alternatively, the biometric data obtained in Step 904 could be that obtained by the sensors 104-6 at a gate terminal 104.

The biometric data of an individual presenting himself for ticketing or entry to a plane can be compared to database entries of record in Step 906 and, if a match is found in Step 908, law enforcement can be notified in Step 910 or authorization granted to the traveler in Step 912 to board the common carriage device. In Step 914, security personnel could detain a suspect passenger for interrogation.

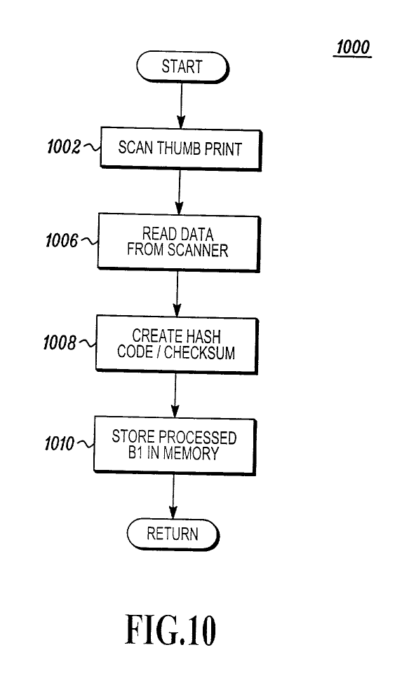

FIG. 10 shows a simplified depiction of the steps involved in scanning biometric characteristics using the aforementioned Veridicom capacitive fingerprint scanner. In Step 1002, a command from the processors 102-2 or 104-2 to the sensors 102-6 or 104-6 reads the raster-scan data from the scanners in Step 1006 into a file. In one embodiment, a hash code can be calculated or a check sum calculated in order to reduce the size of the data obtained from a large pixel-count scanner in Step 1008. The scan and process data is stored in Step 1010 in either the local memories 102-4 or 104-4 or alternatively can be stored on the server 108 via the network 106.

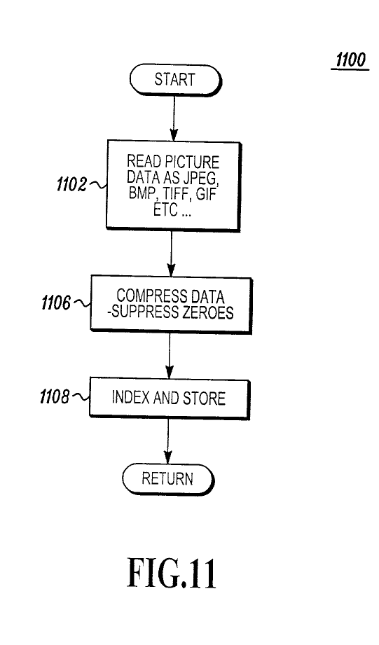

FIG. 11 shows the steps of a procedure 1100 by which image data from the cameras 102-8 is processed. In Step 1102, data from the camera 102-8 is read by the processor 102-2 and compressed in Step 1104 for storage. An identification number can be assigned to the data structure of the data stored in Step 1104 by which a ticket number issued by the ticket terminal 102 is used to index and store the photograph data.

It should be evident from the foregoing that an improved method and apparatus for providing secured transit to individuals using common carriers as provided using biometric data in the form of fingerprint data, retinal scans, DNA, or voice prints. Among other things, a ticketing agent can verify using well-known documents that an individual requesting a ticket and passage on a common carrier has what appears to be legitimate documentation identifying the person to the gate agent. Photographing the individual and obtaining a biometric sample fingerprint might subsequently identify the individual to law enforcement as an individual who perpetrated a criminal act on or using the common carrier device.

What is claimed is:

1. A method of securing the passage of air travelers comprising the steps of:
obtaining at least a first measurement of a biometric characteristic of a prospective air traveler before authorizing passage of said prospective air travel;
prior to allowing individuals to board an airplane, obtaining a boarding-time measurement of said biometric characteristic of individuals seeking to board the airplane;
comparing the first measurement of said biometric characteristic of said air traveler, to the boarding-time measurements of said biometric characteristic of individuals seeking to board the airplane to determine if the first measurement of said biometric characteristic of said air traveler, substantially matches the biometric characteristic of an individual either: seeking to board the airplane, or who has boarded the airplane.

2. A method of securing the passage of air travelers comprising the steps of:
upon an air traveler's check in at an airport, obtaining at least a first measurement of a biometric characteristic of said air traveler;
issuing an authorization for said air traveler to board an airplane upon said first measurement of said biometric characteristic;
prior to allowing individuals to board an airplane, obtaining a boarding-time measurement of said biometric characteristic of individuals boarding the airplane;
comparing the first measurement of said biometric characteristic of said air traveler at check in, to the boarding-time measurements of said biometric characteristic of individuals boarding an airplane to determine if the check-in biometric characteristic of said air traveler corresponds to the boarding-time biometric characteristic of an individual boarding the airplane.

3. A method of identifying air travelers comprising the steps of:
upon an air traveler's check in at an airport, obtaining a check-in measurement of a first biometric characteristic of said air traveler;
upon an air traveler's check-in, obtaining a digital check-in photograph of said traveler;
correlating said air traveler's check-in first biometric characteristic to said air traveler's check-in photograph;
upon said check-in measurement of said biometric characteristic and upon obtaining said check-in photograph, issuing to said air traveler, a boarding authorization device;
upon presentation of said boarding authorization device to board an airplane, obtaining at least one of:
a boarding-time measurement of said first biometric characteristic and a boarding-time photograph of individuals to board the airplane;
comparing at least one of: the check-in first biometric characteristic of said air traveler and the check-in photograph, to: the corresponding boarding-time measurement of said first biometric characteristic and the boarding time photograph to determine if the air traveler is either boarding the plane or seeking to board the plane.

4. A method of identifying air travelers comprising the steps of:
upon an air traveler's check in at an airport, obtaining at least a first measurement of a first biometric characteristic of said air traveler to create a numeric representation of said biometric characteristic of said air traveler;
authorizing said air traveler to board an airplane upon said first measurement of said biometric characteristic;
prior to allowing individuals to board an airplane, obtaining a boarding-time measurement of said first biometric characteristic of individuals to board the airplane;
comparing the first biometric characteristic of said air traveler at check in, to the boarding-time measurements of said first biometric characteristic of individuals boarding an airplane to determine if the identity of the air traveler at check-in, corresponds to the identity of an individual boarding the plane;
upon detecting a mismatch between the biometric characteristic of said air traveler at check and the biometric characteristics of individuals boarding an airplane, inhibiting the departure of said airplane from said airport.

5. A method of identifying air travelers comprising the steps of:
obtaining from a prospective air traveler, at least a first measurement of a first biometric characteristic to create a numeric representation of said biometric characteristic of said prospective air traveler;
copying said numeric representation of said biometric characteristic to a boarding authorization device for a predetermined flight, for the prospective air traveler;
issuing said boarding authorization device for said predetermined flight to said air traveler;
prior to allowing individuals to board an airplane for said predetermined flight:
obtaining from individuals seeking to board the airplane, a boarding-time measurement of said first biometric characteristic;
obtaining from individuals seeking to board the airplane, boarding authorization devices;
comparing said boarding-time measurements of said first biometric characteristic of individuals seeking to board the airplane to the numeric representation of said first biometric characteristic copied onto said boarding authorization devices to determine if said air traveler is either aboard the airplane or seeking to board the airplane; and
inhibiting the departure of said airplane if said air traveler is not aboard.

6. A method of identifying air travelers comprising the steps of:
obtaining at least a first measurement of a first biometric characteristic of an air traveler;
obtaining a digital photograph of said air traveler;
storing said digital photograph of said air traveler and said biometric characteristic of said air traveler;
transmitting at least one of said digital photograph of said air traveler and said biometric characteristic of said air traveler to a law enforcement agency data base;
upon said first measurement of said biometric characteristic, issuing to said air traveler, an authorization device enabling said air traveler to board a predetermined airplane;
obtaining a boarding-time measurement of said first biometric characteristic of individuals to board said predetermined airplane;
comparing the first measurement of said first biometric characteristic of said air traveler, to the boarding-time measurements of individuals boarding said predetermined airplane to determine if the air traveler at check-in is either boarding the predetermined airplane, or has boarded the predetermined airplane.

7. A method of securing the passage of individuals on a common carrier comprising the steps of:
obtaining at least a first measurement of a first biometric characteristic of a prospective traveler;
comparing said first biometric characteristic of said prospective air traveler to the first biometric characteristics of individuals in a first data base;
notifying at least one law enforcement agency of the correspondence of said first biometric characteristic of a prospective traveler to the biometric characteristic of an individual in said first data base.

8. A method of securing the passage of individuals on a common carrier comprising the steps of:
obtaining at least a first measurement of a first biometric characteristic of a prospective traveler;
comparing said first biometric characteristic of said prospective traveler to the first biometric characteristic of a plurality of individuals in a first data base;
inhibiting the passage of said prospective traveler on said common carrier if said first biometric characteristic of said prospective traveler substantially corresponds to the first biometric characteristic of at least one individual of said plurality of individuals in said first data base.

9. A method of securing the passage of individuals on a common carrier comprising the steps of:
receiving access to first data base of biometric characteristics of individuals;
obtaining from a prospective traveler, a first biometric characteristic of said prospective traveler;
comparing said first biometric characteristic of said prospective air traveler to the biometric characteristics in said first data base;
issuing a boarding authorization device to said prospective traveler based upon the result of comparing said first biometric characteristic of said prospective air traveler to the biometric characteristics in said first data base;
prior to allowing individuals to board a carriage device, obtaining from each of said individuals, boarding authorization devices; and
at the time of boarding a carriage device, obtaining from each individual seeking to board said carriage device, a boarding-time measurement of said first biometric characteristic;
comparing said boarding time measurement of said first biometric characteristic to previously-obtained first biometric characteristics and to said biometric characteristics in said data base;
inhibiting the departure of said carriage device based upon the results of the step of comparing said boarding time measurement of said first biometric characteristic to previously-obtained first biometric characteristics and to said biometric characteristics in said data base.

10. A method of identifying passengers boarding a common carrier comprising:
determining a first biometric characteristic of an individual;
generating data representing the biometric characteristic of said individual;
copying said data representing said biometric characteristic onto a boarding pass for said common carrier;
recovering said boarding pass from said individual as a condition to boarding said common carrier.

11. A common carrier security system comprised of:
a check-in terminal comprised of:
at least a first biometric sensor for measuring a first biometric characteristic of an individual when said individual is proximate to said check-in terminal;
a first computer operatively coupled to said first biometric sensor and generating a first numeric representation of said first biometric characteristic;
a gate terminal comprised of:
at least a second biometric sensor for measuring said first biometric characteristic of an individual when said individual is proximate to said gate terminal;
a second computer operatively coupled to said second biometric sensor and generating a second numeric representation of said second biometric characteristic;
a server computer, for enabling the comparison of said first biometric characteristic to said second biometric characteristic and for enabling the determination of whether said first and second characteristics are substantially the same;
a data network, operatively coupling together said check-in terminal, said gate terminal and said server.

12. A common carrier security system comprised of:
a check-in terminal comprised of:
at least a first biometric sensor for measuring a first biometric characteristic of an individual when said individual is proximate to said check-in terminal;
a first computer operatively coupled to said first biometric sensor and generating a first numeric representation of said first biometric characteristic;
a gate terminal comprised of:
at least a second biometric sensor for measuring said first biometric characteristic of an individual when said individual is proximate to said gate terminal;
a second computer operatively coupled to said second biometric sensor and generating a second numeric representation of said second biometric characteristic, said second computer comparing said first biometric characteristic to said second biometric characteristic and determining whether said first and second characteristics are substantially the same;
a data network, operatively coupling together said check-in terminal, said gate terminal and for sending a signal that said first and second biometric characteristics were determined to not be substantially the same.

13. A common carrier security system comprised of:
a terminal comprised of:
at least a first biometric sensor for measuring a first biometric characteristic of an individual when said individual is proximate to said check-in terminal;
a first computer operatively coupled to said first biometric sensor and generating a first numeric representation of said first biometric characteristic.
